(19) United States
(12) Patent Application Publication
(10) Pub. No.: US 2013/0335362 A1
(43) Pub. Date: Dec. 19, 2013

(54) TOUCH PANEL CONTROL CIRCUIT, DRIVE CIRCUIT OF DISPLAY DEVICE, AND DISPLAY DEVICE

(71) Applicants: Jin Miyazawa, Osaka-shi (JP); Atsushi Okada, Osaka-shi (JP); Tomohiko Nishimura, Osaka-shi (JP); Masashi Mayumi, Osaka-shi (JP)

(72) Inventors: Jin Miyazawa, Osaka-shi (JP); Atsushi Okada, Osaka-shi (JP); Tomohiko Nishimura, Osaka-shi (JP); Masashi Mayumi, Osaka-shi (JP)

(73) Assignee: Sharp Kabushiki Kaisha, Osaka-shi, Osaka (JP)

(21) Appl. No.: 14/002,514

(22) PCT Filed: Mar. 1, 2012
(86) PCT No.: PCT/JP2012/055175

§ 371 Date: Aug. 30, 2013

(30) Foreign Application Priority Data
Mar. 7, 2011 (JP) 2011-049063

(51) Int. Cl. G09G 5/12; G06F 3/041

(52) U.S. Cl. CPC G09G 5/12; G06F 3/0416
USPC 345/173; 345/87

(57) ABSTRACT

A touch panel control circuit includes a switch signal generation circuit, a touch panel drive signal generation circuit that generates a touch panel drive signal, and a synchronizing signal generation circuit. The switch signal generation circuit generates a switch signal corresponding to a generation timing of the touch panel drive signal. The switch signal specifies a switching period during which a switching liquid crystal drive signal driving a switching liquid crystal panel is switched to a touch panel drive signal and supplied to a common board that is commonly used for a touch panel and a switching liquid crystal panel. The synchronizing signal generation circuit generates a synchronizing signal that starts switching from the switching liquid crystal drive signal to the touch panel drive signal at a predetermined period.

### TECHNICAL FIELD

The present invention relates to a touch panel control circuit, a drive circuit of a display device including the touch panel control circuit, and a display device. Especially, the present invention relates to a technology related to signals supplied to a touch panel and a parallax barrier in a display device including the touch panel and the parallax barrier.

### BACKGROUND ART

A display device including a display panel such as a liquid crystal panel is used for a portable terminal device such as a mobile phone and PDA or an electronic device such as a computer and a television. A parallax barrier is applied to such a display device to display a stereoscopic image. Using a parallax barrier, each of a left eye and a right eye sees a different image and human beings sense a stereoscopic image due to binocular parallax. Patent Document 1 discloses one example of such a display device having a function of displaying stereoscopic images.

The display device disclosed in Patent Document 1 includes a touch panel, a display panel such as a liquid crystal panel and a layer of switching liquid crystal (parallax barrier). Pixels for a right eye and pixels for a left eye are displayed on the display panel, and an observer can see the pixels for a right eye with his/her right eye and see the pixels for a left eye with his/her left eye through slits formed in the layer of switching liquid crystal. Accordingly, the observer can see a stereoscopic image caused by the binocular parallax.
Patent Document 1: Japanese Unexamined Patent Application Publication No. 2004-272354

### PROBLEM TO BE SOLVED BY THE INVENTION

The number of components is increased and a thickness and a weight of a whole device are also increased in the display device that displays stereoscopic images compared to a display device that displays only two-dimensional images. The display device including an input device such as a touch panel is further increased in its thickness and weight. The display device including a touch panel and having the function of displaying stereoscopic images is required to be reduced in thickness and weight. To achieve this, the touch panel and the parallax barrier may be commonly and integrally formed on one common board, and a common electrode may be mounted on the common board. A signal (an synthesized signal) that is obtained by synthesizing the touch panel drive signal and the switch signal is supplied to the common electrode. However, the touch panel drive signal and the switching liquid crystal drive signals are normally generated separately from each other, and the signals are not synchronous with each other. Therefore, switching is necessarily carried out based on one of the signals to generate a synthesized signal. For example, switching is carried out based on the touch panel drive signal. A sensing rate of a touch panel control IC (a touch panel driver) or an interval of output timing of a detection control signal of a touch panel drive signal changes due to internal processing influences caused by the number of fingers of a user who touches the touch panel. To cover such a change, it is required to prolong a select time period (a switching time period) for selecting a touch panel drive signal to generate a synthesized signal. In such a case, the touch panel drive signal may greatly influence the switching liquid crystal drive signal.

### DISCLOSURE OF THE PRESENT INVENTION

The present invention was accomplished in view of the foregoing circumstances. An object of the present invention is to provide a technology of generating a synthesized signal simply and effectively with a touch panel drive signal and a switching liquid crystal drive signal that are not synchronous with each other.

### MEANS FOR SOLVING THE PROBLEM

To solve the above problem, a touch panel drive circuit of the present invention drives a touch panel of a display device including a display panel, a touch panel provided on a display surface side of the display panel, and a parallax barrier configured with a switching liquid crystal panel that enables three-dimensional display. The display device includes a common board that is commonly used as a base board of the touch panel and one of two base boards of the switching liquid crystal panel, and further includes a plurality of touch panel electrodes and switching liquid crystal electrodes provided on a same plane of the common board. The touch panel drive circuit includes a touch panel drive signal generation circuit configured to generate a touch panel drive signal that drives the touch panel, and a switch signal generation circuit configured to generate a switch signal corresponding to a generation timing of the touch panel drive signal. The switch signal specifies a switching period during which a switching liquid crystal drive signal driving the switching liquid crystal panel is switched to the touch panel drive signal to be supplied to the common board. The touch panel drive circuit further includes a synchronizing signal generation circuit configured to generate a synchronizing signal that starts switching from the switching liquid crystal drive signal to the touch panel drive signal at a predetermined period.

With this configuration, the switch signal generation circuit generates a switch signal corresponding to a generation timing of the touch panel drive signal. The switch signal specifies a switching period during which a switching liquid crystal drive signal driving the switching liquid crystal panel is switched to the touch panel drive signal to be supplied to the common board. The synchronizing signal generation circuit generates a synchronizing signal that starts switching from the switching liquid crystal drive signal to the touch panel drive signal at a predetermined period. Therefore, with using the switch signal and the synchronizing signal, the synthesizing signal supplied to the common board is generated easily and effectively from the touch panel drive signal and the switching liquid crystal drive signal that are not synchronous with each other.

A drive circuit of a display device may include the above touch panel control circuit, a switching liquid crystal drive signal generation circuit configured to generate the switching liquid crystal drive signal, and a synthesizing circuit configured to switch from the switching liquid crystal drive signal to the touch panel drive signal in response to the switch signal and generate a synthesized signal and supply the synthesized signal to the common board.

With this configuration, the synthesized signal is effectively generated.

In the configuration of the drive circuit, a common electrode may be mounted on the common board to be commonly used as the touch panel electrode and the switching liquid crystal electrode, and the synthesizing circuit may supply the synthesized signal to the common electrode.

With this configuration, the electrodes are commonly used on the common board and this simplifies wiring on the common board.

In the configuration of the above drive circuit, the synthesizing circuit may be initialized by the synchronizing signal in generating the synthesized signal.

With this configuration, the synthesizing signal is easily initialized.

A display device includes any one of the above described drive circuits. The display panel may be a liquid crystal display panel using liquid crystals.

Such a display device is applied to various uses such as a mobile phone, a smart phone, a portable game machine, a notebook computer, a desktop of a personal computer or a television device as a liquid crystal display device, and especially appropriate for a display screen of various sizes.

### ADVANTAGEOUS EFFECT OF THE INVENTION

According to the present invention, a synthesized signal is generated easily and effectively with a touch panel drive signal and a switching liquid crystal drive signal that are not synchronous with each other.

### BRIEF DESCRIPTION OF THE DRAWINGS

FIG. 1 is a cross-sectional view illustrating a general construction of a display device according to one embodiment.

FIG. 2 is a plan view typically illustrating electrodes mounted on a common board according to one embodiment.

FIG. 3 is a plan view typically illustrating a second switching liquid crystal panel electrode included in the display device of FIG. 1.

FIG. 4 is a plan view typically illustrating a second touch panel electrode.

FIG. 5 is a block diagram illustrating a general construction for generation of a common electrode signal according to one embodiment.

FIG. 6 is a block diagram typically illustrating a synthesizing circuit according to one embodiment.

FIG. 7 is a timing chart generally illustrating signals of each electrode according to one embodiment.

FIG. 8 is a timing chart generally illustrating each signal according to one embodiment.

FIG. 9 is a block diagram generally illustrating a construction for generation of a common electrode signal according to one embodiment.

FIG. 10 is a block diagram generally illustrating another synthesizing circuit.

### MODES FOR CARRYING OUT THE INVENTION

### First Embodiment

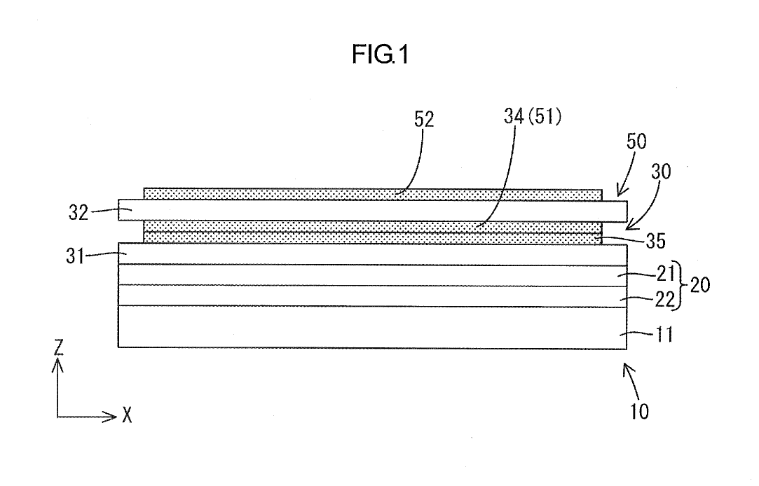

A first embodiment will be explained with reference to FIGS. 1 to 9. In the first embodiment, a liquid crystal display device 10 (display device) will be described as an example. The liquid crystal display device 10 is used as an information display element included in various electronic devices such as a portable information terminal, a mobile phone, a notebook computer, a portable game machine (not illustrated). An X-axis, a Y-axis and a Z-axis are described in a part of some drawings. A long-side of the liquid crystal display device 10 corresponds to the X-axis and a short-side thereof corresponds to the Y-axis. The up-down direction in FIG. 1 corresponds to the Z-axis (a front-rear direction, a direction vertical to a screen), and an upper side in FIG. 1 is a front-surface side and a lower side in FIG. 1 is a rear-surface side.

1. Entire Configuration of Liquid Crystal Display Device

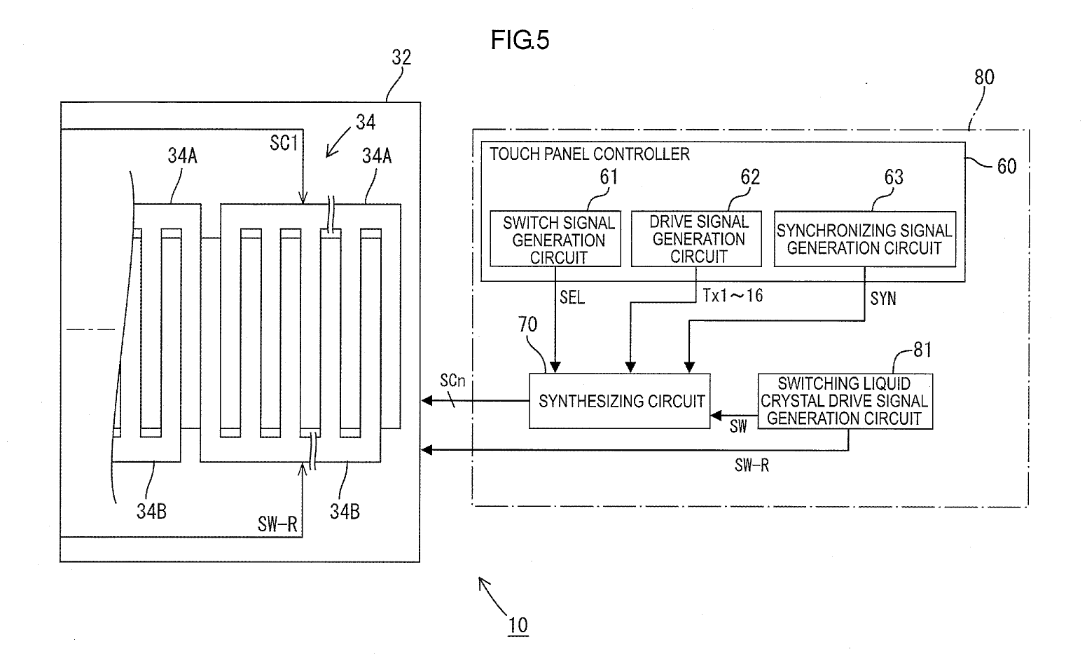

The liquid crystal display device 10 has a landscape quadrangular shape (rectangular shape) as a whole. As illustrated in FIG. 1, the liquid crystal display device 10 includes a backlight device 11, a liquid crystal panel 20 (a display panel), a switching liquid crystal panel 3, a touch panel 50, and a drive circuit 80 (see FIG. 5). The liquid crystal panel 20, the switching liquid crystal panel 30 and the touch panel 50 are laminated on the backlight device 11 in this order. The touch panel 50 and the switching liquid crystal panel 30 are provided on a display surface side of the liquid crystal display panel 20. The liquid crystal display panel 20, the switching liquid crystal panel 30 and the touch panel 50 are connected to the drive circuit 80 of the liquid crystal display device 10 via a flexible board (not illustrated), for example.

The backlight device 11 includes a chassis and light sources (for example, cold cathode tubes or LEDs (not illustrated)). The chassis is formed in substantially a box shape having an opening that is open to a front-surface side (a liquid crystal display panel 20 side) and the light sources, a light guide plate, a directivity control film, a diffuser sheet, and a reflection sheet are housed in the chassis. The backlight device 11 exits light toward the liquid crystal display panel 20.

The liquid crystal display panel 20 includes a pair of transparent (highly capable of light transmission) glass substrates 21, 22 and a liquid crystal layer (not illustrated) containing liquid crystal molecules that changes its optical property according to impressing of an electric field. The liquid crystal layer is provided between the pair of transparent glass substrates 21, 22. The transparent glass substrates 21, 22 are bonded together with a sealing agent with ensuring a gap corresponding to a thickness of the liquid crystal layer. An image is displayed on the liquid crystal display panel 20 with a frame frequency of 60 Hz.

The transparent glass substrate 21 that is provided on a front-surface side (au upper side in FIG. 1) is a CF board 21 and the transparent glass substrate 22 that is provided on a rear-surface side is a TFT board 22 (an element board). A plurality of TFTs (thin film transistor) and pixel electrodes are arranged on an inner surface (a surface close to the liquid crystal layer, a surface facing the CF board 21) of the TFT board 22 (not illustrated). The TFT is a switching component. Source lines and gate lines that are arranged in a grid pattern are provided to surround each of the TFTs and the pixel electrodes. The gate lines and the source lines are connected to gate electrodes and source electrodes of the TFTs, respectively, and the pixel electrodes are connected to drain electrodes of the TFTs.

Color filters having color sections such as R (red), G (green) and B (blue) color sections arranged corresponding to each pixel are provided on the CF board 21. A light blocking layer (a black matrix) is formed between the color sections of the color filter to prevent mixing of colors. Counter electrodes are provided on surfaces of the color filter and the light blocking layer so as to face the pixel electrodes on the TFT board 22. An alignment film is provided on an inner surface of each of the boards 21, 22 to arrange an alignment of liquid crystal molecules contained in the liquid crystal layer. A polarizing plate (not illustrated) is provided on an outer surface of each board 21, 22.

The switching liquid crystal panel 30 and the touch panel 50 are integrally provided on a front surface side (an upper side in FIG. 1) of the liquid crystal display panel 20.

The switching liquid crystal panel 30 is arranged in adjacent to the liquid crystal display panel 20 and capable of switching a display mode between a two-dimensional display mode and a three-dimensional display mode. The switching liquid crystal panel 30 includes a transparent (capable of light transmission) glass boards 31, 32, a liquid crystal layer (not illustrated) that is provided between the boards 31, 32, and a polarizing plate provided on an outer surface of the liquid crystal layer. The glass board 32 that is provided away from the liquid crystal display panel 20 configures a part of the touch panel 50 and is used commonly for the switching liquid crystal panel 30 and the touch panel 50. Therefore, the glass board 32 is referred to as a common board.

The switching liquid crystal panel 30 includes switching liquid crystal panel electrodes 34, 35 that apply a voltage to the liquid crystal layer arranged between the boards 31 and 32. Each of the electrodes 34, 35 is a transparent electrode and extends in a different direction.

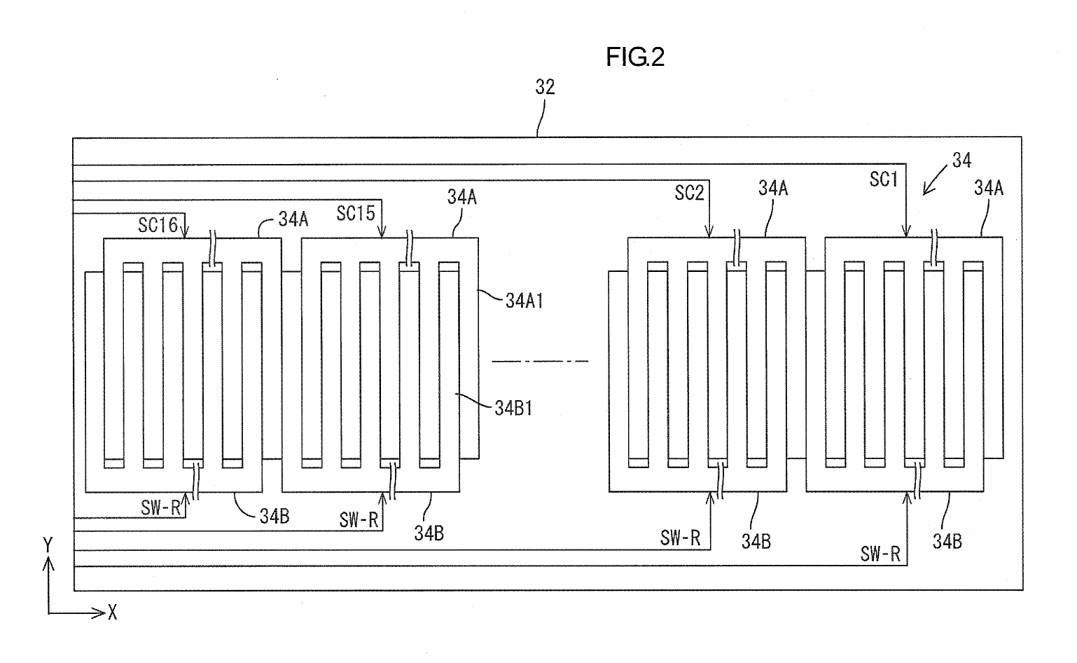

The first switching liquid crystal panel electrode 34 that is provided close to the touch panel 50 and provided on the common board 32 extends in the Y-axis direction (along one side of the liquid crystal display device 10), as illustrated in FIG. 2. Specifically, the first switching liquid crystal panel electrode 34 includes a plurality pairs of comb-shaped electrodes 34A, 34B that are arranged in the X-axis direction. In this embodiment, sixteen pairs of electrodes 23A, 34B are arranged. In one pair of the electrodes 34A, 34B, an extending portion 34B1 (extending in the Y-axis direction) of the electrode 34B is provided between extending portions 34A1 (extending in the Y-axis direction) of the electrode 34A. Each of the electrodes 34A, 34B is configured with twenty five extending portions 34A1, 34B1.

The first switching liquid crystal panel electrode 34 configures apart of a transparent electrode of the touch panel 50. The first switching liquid crystal panel electrode 34 is used commonly for the switching liquid crystal panel 30 and the touch panel 50 and may be referred to as a common electrode 34.

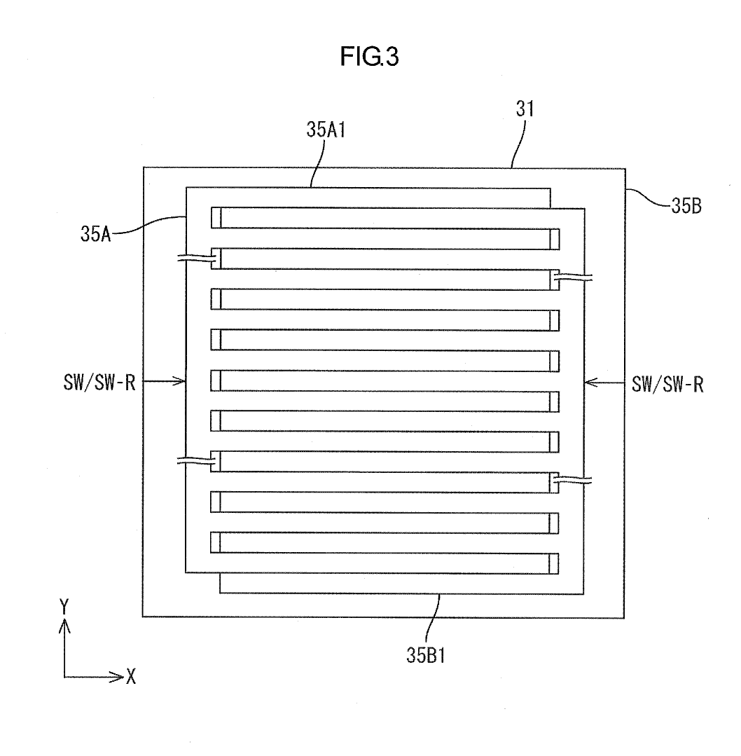

As illustrated in FIG. 3, a second switching liquid crystal panel electrode 35 that is provided on the glass board 31 and close to the liquid crystal display panel 20 extends in the X-axis direction. Specifically, the second switching liquid crystal panel electrode 35 includes a plurality pairs of comb-shaped electrodes 35A, 35B that are arranged in the X-axis direction. In one pair of the electrodes 35A, 35B, an extending portion 35B1 (extending in the X-axis direction) of the electrode 35B is provided between extending portions 35A1 (extending in the X-axis direction) of the electrode 35A. A part of the pair of electrodes 35A, 35B is illustrated in FIG. 3.

A switching liquid crystal drive signal SW that is a parallax barrier drive signal (having a positive and negative symmetrical rectangular waveform in this embodiment) is applied to the electrode 34A of the electrodes 34A and 34B included in the first switching liquid crystal panel electrode 34, and the electrode 34B and the second switching liquid crystal panel electrodes 35A, 35B are grounded. Then, light (that is exited from the backlight device 11 and transmitted through the liquid crystal display panel 20) is transmitted only through the portions of the switching liquid crystal panel 30 corresponding to the extending portions 34A1 of the electrode 34A. Namely, the switching liquid crystal panel 30 is a normally white type. Accordingly, in the liquid crystal display panel 20, one group of pixels can be seen by a right eye and another group of pixels can be seen by a left eye. The switching liquid crystal panel 30 functions as a parallax barrier for a landscape position (a horizontal position) and this enables three-dimensional display.

A switching liquid crystal drive signal SW (having a positive and negative symmetrical rectangular waveform in this embodiment) is applied to one of the electrodes 35A, 35B of the second switching liquid crystal display panel electrode 35, for example, the electrode 35A, and the electrode 35B and the first switching liquid crystal panel electrodes 34A, 34B are grounded. Then, the light (that is exited from the backlight device 11 and transmitted through the liquid crystal display panel 20) is transmitted only through the portions of the switching liquid crystal panel 30 corresponding to the extending portions 35A1 of the electrode 35A. Accordingly, in the liquid crystal display panel 20, one group of pixels can be seen by a right eye and another group of pixels can be seen by a left eye. The switching liquid crystal panel 30 functions as a parallax barrier for a portrait position (a vertical position) and this enables three-dimensional display.

In the present embodiment, the liquid crystal display device 10 includes two types of the switching liquid crystal panel electrodes 34, 35 that extend indifferent directions. Therefore, a parallax barrier is created in the long-side direction and the short-side direction of the liquid crystal display device 10, and the three-dimensional display is enabled in both cases in which the display device 10 is in the vertical position and in the horizontal position.

Pixels for a right eye and pixels for a left eye are displayed on the liquid crystal display panel 20. A user of the liquid crystal display device 10 can see the right eye pixels with his/her right eye and see the left eye pixels with his/her left eye via the light transmission portions formed on the switching liquid crystal panel 30. A predetermined AC voltage is not applied to the first switching liquid crystal panel electrode 34 and the second switching liquid crystal panel electrode 35, and accordingly the light transmission portions are formed on an almost entire area of the switching liquid crystal display panel 30. This enables the two-dimensional display.

The AC voltage is obtained by generating a positive and negative symmetrical rectangular waveform having approximately ±5V or generating a unipolar rectangular waveform with a reverse phase of approximately 0/5V. In the present embodiment, a unipolar rectangular waveform with a reverse phase of approximately 0/5V is preferably generated. In this method, if an AC voltage with a same phase is applied to each of the electrodes 34, 35 holding the switching liquid crystal layer therebetween, any voltage is applied to the liquid crystal layer, and if a voltage with a reverse phase is applied to the electrodes 34, 35, an AC voltage is applied to the liquid crystal layer and this changes transmission of the liquid crystal layer.

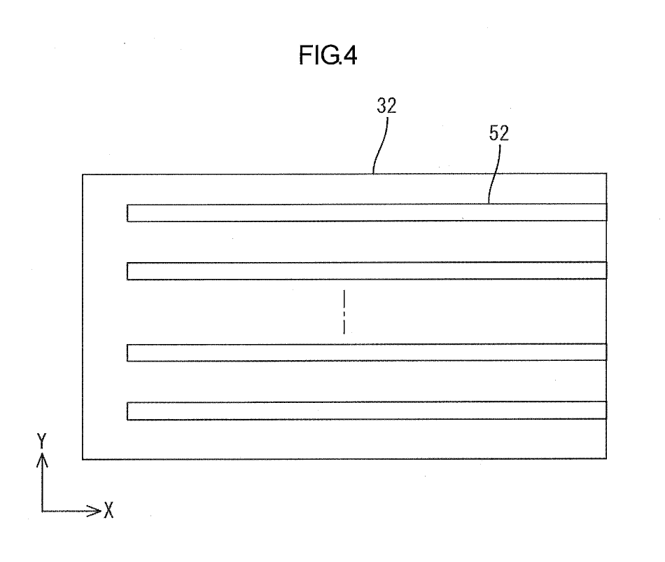

The touch panel 50 includes the common board 32 and touch panel electrodes 51, 52 each of which is a transparent electrode and provided on a front surface and a rear surface of the common board 32. Specifically, the common electrode 34 provided on the lower surface of the common board 32 and extending in the Y-axis direction is used as the first touch panel electrode 51. As illustrated in FIG. 4, the second touch panel electrode 52 is provided on the upper surface of the common board 32 and extends in the X-axis direction (a direction perpendicular to the first touch panel electrode 51).

Data (for example, coordinate data on the touch panel 50) is input via the touch panel 50 according to change in electrostatic capacity between the first touch panel electrode 51 (the common electrode 34) and the second touch panel electrode 52 that is generated by touching of the surface of the touch panel 50 with a finger. The touch panel 50 of the present embodiment is a touch panel of a mutual capacitance sensing method. For example, if a user touches the touch panel 50 with his/her finger while a touch panel drive signal Txn configured with a certain number of (four) pulses is sequentially applied to the first touch panel electrode 34A, an electrostatic capacity within a detection circuit loop changes. It is determined at which one of crossing points between the first touch panel electrode 34A and the second touch panel transparent electrode 52 the change in the electrostatic capacity occurs. This determination is made based on a waveform of a current that flows via the second touch panel transparent electrode 52 and a timing of application of the touch panel drive signal Txn.

In the present embodiment, the common board 32 is used commonly in the touch panel 50 and the switching liquid crystal panel 30. Both of the touch panel 50 and the switching liquid crystal panel 30 require a transparent electrode extending in the Y-axis direction. Accordingly, the transparent electrode (34A or 34B) extending in the Y-axis direction is commonly used for the both panels 30, 50.

2. Electric Configuration Relating to Generation of Common Electrode Signal (Synthesized Signal)

Next, an electric configuration relating to generation of a common electrode signal (one of examples of a synthesized signal) SCn supplied to the common electrode 34 will be explained with reference to FIGS. 5 to 9.

As illustrated in FIG. 5, the liquid crystal display device 10 includes the drive circuit 80 (one of examples of a drive circuit of the display device). The drive circuit 80 includes a touch panel controller (one of examples of a touch panel control circuit) 60, a synthesizing circuit 70, and a switching liquid crystal drive signal generation circuit (referred to as a SW signal generation circuit hereinafter) 81 as a generation circuit for generating a common electrode signal SCn (n=an integral number of 1-16). The drive circuit 80 further includes a display panel driver (not illustrated) that drives the liquid crystal display panel 20 and a backlight driver (not illustrated) that drives the backlight device 11.

The touch panel controller 60 is configured with one IC (Integrated Circuit), for example, and includes a switch signal generation circuit 61, a touch panel drive signal generation circuit 62, and a synchronizing signal generation circuit 63.

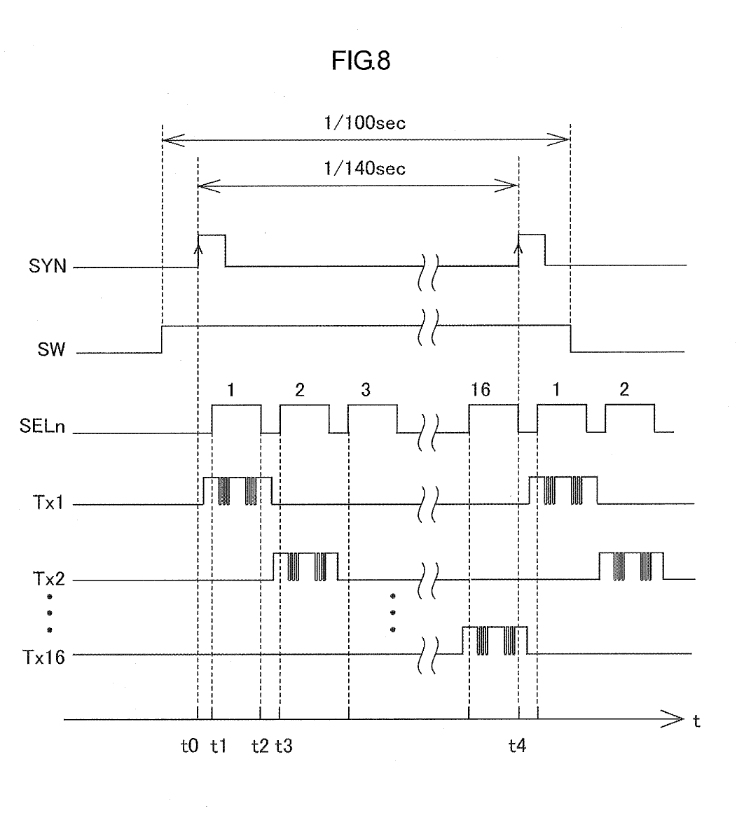

The switch signal generation circuit 61 generates a switch signal SEL corresponding to a generation timing of a touch panel drive signal Txn. The switch signal SEL designates a switching period during which the switching liquid crystal drive signal SW is switched to the touch panel drive signal Txn to be supplied to the common board 32. According to the present embodiment, as illustrated in FIG. 8, the switch signal SEL is a pulse signal having a certain pulse period and sixteen pulses are included in one touch panel signal period. For example, the touch panel signal period is 140 Hz and in such a case, the certain pulse period of the pulse signal of the switch signal SEL is (( 1/140)/16) seconds.

The touch panel drive signal generation circuit 62 generates the touch panel drive signal Txn (n=an integral number of 1-16) that drives the touch panel 50. As illustrated in FIG. 8, each touch panel drive signal Txn is a signal corresponding to each switch signal SEL and has a signal period longer than a pulse width of the switch signal SEL. In FIG. 8, the touch panel drive signals Txn are described separately from each other. However, the touch panel drive signal generation circuit 62 continuously generates the touch panel drive signals Txn.

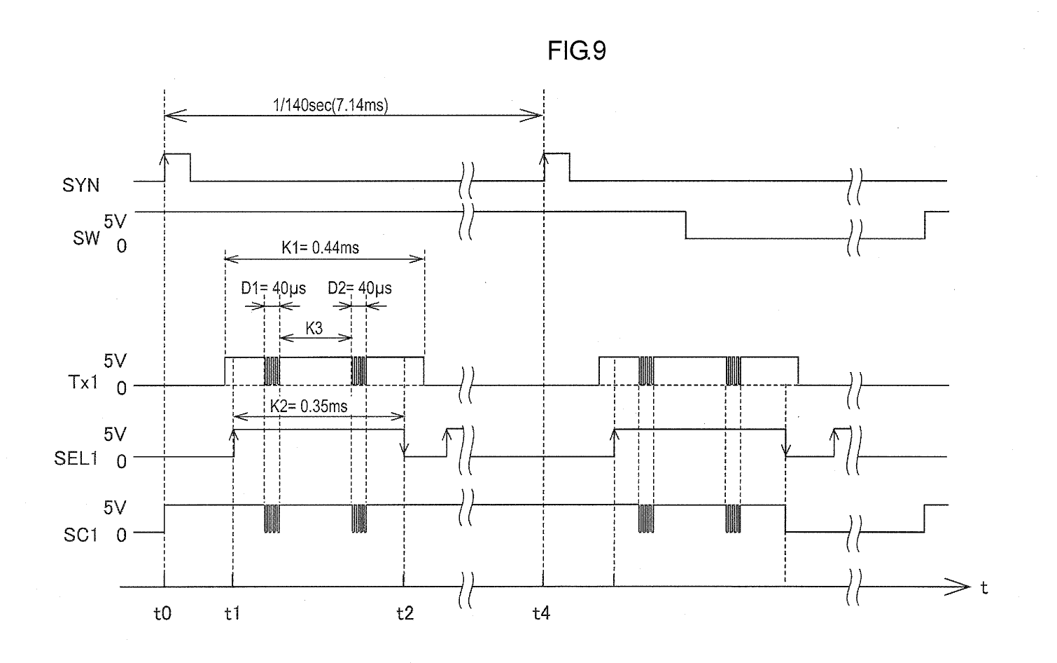

Specifically, as illustrated in FIG. 9, the touch panel drive signal generation circuit 62 generates sixteen touch panel drive signals (Tx1-Tx16) at a certain period that is 1/140 seconds or approximately 7.14 ms (milliseconds) (hereinafter referred to as a sensing period TSN). Each touch panel drive signal Txn is supplied to the synthesizing circuit 70. In the present embodiment, each touch panel drive signal (Tx1-Tx16) has a 5V-voltage and a signal period K1 of approximately 0.44 ms, as illustrated in FIG. 9.

The signal period K1 includes two detection pulse periods D1, D2. During each of the detection pulse periods D1, D2, the voltage changes between an L-level (0V) and an H-level (5V) at a plurality of times, for example, four times. A frequency of the detection pulse is, for example, from several tens KHz to several hundreds KHz. If the frequency of the detection pulse is several hundreds KHz, each of the detection pulse periods D1, D2 is approximately 40 μS (see FIG. 9). Each of the detection pulse periods D1, D2 is preferably 100 microseconds or less. If the detection pulse period D1, D2 is longer than 100 microseconds, a timing of scanning rate is delayed and this deteriorates responsiveness of the touch panel 50. An interval K3 between the detection pulse periods D1, D2 is not constant and may change according to touch of a user's finger to the touch panel 50.

Voltage of the touch panel drive signal Txn is preferably equal to or less than voltage of the switching liquid crystal drive signal SW. The touch panel drive signal Txn and the switching liquid crystal drive signal SW are synthesized. Therefore, if an effective value of the touch panel drive signal Txn is too high, an operation of the switching liquid crystals may be affected, and this may increase crosstalk between right-eye images and left-eye images in the 3D display. This may deteriorate display quality. In the present embodiment, the voltages (an absolute value) of the touch panel drive signal Txn and the switching liquid crystal drive signal SW are same and each of the voltages is 5V.

The synchronizing signal generation circuit 63 generates a synchronizing signal SYN that starts switching the switching liquid crystal drive signal SW to the touch panel drive signal Tx at a certain period. A frequency of the synchronizing signal SYN is 140 Hz, for example, and the certain period is same as the sensing period TSN. Namely, the period of the synchronizing signal SYN is 1/140 seconds that is approximately 7.14 ms.

The switch signal SEL, the touch panel drive signal Txn and the synchronizing signal SYN are supplied to the synthesizing circuit 70.

The SW signal generation circuit 81 generates the switching liquid crystal drive signal SW and supplies the switching signal SW to the synthesizing circuit 70.

In response to the switch signal SEL, the synthesizing circuit 70 switches the switching liquid crystal drive signal SW to the touch panel drive signal Txn (Tx1-Tx16) and generates the synthesized signal SCn (SC1-SC16) and the supplies the synthesized signal SCn to the common board 32. Specifically, the synthesizing circuit 70 scans sequentially and supplies each synthesized signal (SC1-SC16) to a corresponding common electrode 34A of the common board 32.

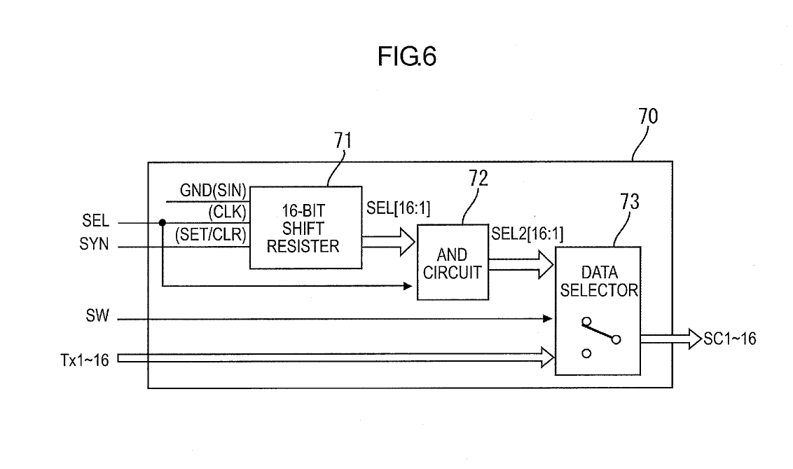

As illustrated in FIG. 6, the synthesizing circuit 70 includes a 16-bit shift register 71, a plurality of (sixteen in the present embodiment) AND circuits 72, and a data select circuit 73. Output from the 16-bit shift register 71 is sequentially supplied to each AND circuit 72 and output from each AND circuit 72 is sequentially supplied to the data select circuit 73. The switch signal SEL and the synchronizing signal SYN are supplied from the touch panel controller 60 to the 16-bit shift register 71. The switch signal SEL is supplied to each AND circuit 72. The touch panel drive signal Txn is supplied from the touch panel controller 60 to the data select circuit 73, and the switching liquid drive signal SW is supplied from the SW signal generation circuit 81 to the data selection circuit 73.

3. Generation of Common Electrode Signal (Synthesized Signal)

Next, with reference to FIGS. 5 to 9, generation of the common electrode signal SCn with the above electric configuration will be explained.

First, driving by the drive circuit 80 of the present embodiment will be generally explained. In the present embodiment, for example, sixteen common electrodes 34A are mounted on the common board 32, and accordingly, sixteen common electrode signals (SC1-SC16) are generated corresponding to each common electrode 34A.

In the present embodiment, a part of the switching liquid crystal drive signal SW is switched to the touch panel drive signal TXn to generate the common electrode signal SCn, and the common electrode signal SCn is supplied to a part of the electrodes 34A, 34B that are arranged on a lower surface of the common board 32. Namely, the common electrode signal SCn is supplied to the electrodes 34A. In such a case, a period of the touch panel drive signal Txn corresponding to each common electrode signal SCn is different. The touch panel drive signal Txn is sequentially applied to the electrode 34A. In the present embodiment, all of the electrodes 34A (sixteen) are used as the common electrodes 34A. However, it is not limited thereto. A part of the electrodes 34A may be used as the common electrodes 34A according to the required number of switching of the touch panel 50. For example, eight out of the sixteen electrodes 34A may be used as the common electrodes 34A and the remaining eight electrodes 34A may be used as the electrodes for only the switching liquid crystal drive signal SW.

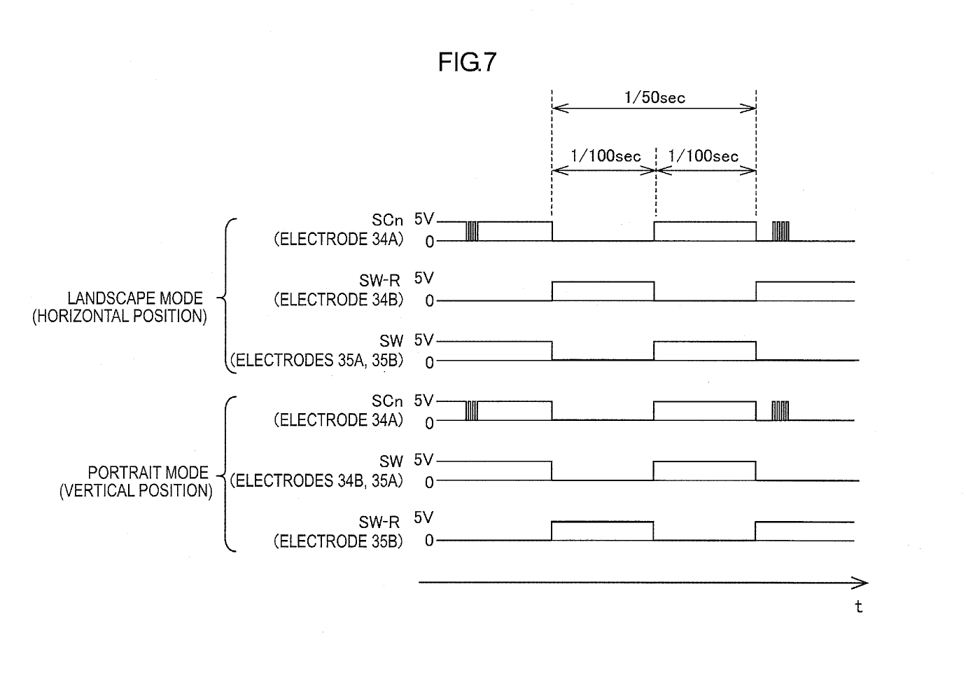

An example of a timing chart of signals applied to each wiring 34, 35 of the common board 32 is illustrated in FIG. 7. As illustrated in FIG. 7, in a landscape mode (in a horizontal position), the common electrode signal SCn (SC1-SC16) is applied to each common electrode 34A and the electrode 34B receives the switching liquid crystal drive signal SW (hereinafter, referred to as a reverse phase switching liquid crystal drive signal SW-R) that has an amplitude same as the switching liquid crystal drive signal SW included in the common electrode signal SCn and has a rectangular waveform with a reverse phase. In this case, the switching liquid crystal drive signal SW has a rectangular waveform with a frequency of 60 Hz and a voltage of 5V. The switching liquid drive signal SW that is same as that applied to the electrode 34A is applied to the electrodes 35A, 35B. In case of FIG. 7, the parallax barrier is generated by the electrode 34B.

In a portrait mode (in a vertical position), the common electrode signal SCn is applied to the common electrode 34A and the reverse phase switching liquid crystal drive signal SW-R is applied to the electrode 35B. The switching liquid crystal drive signal SW same as that applied to the electrode 34A is applied to the electrodes 34A, 35A. In case of FIG. 7, the parallax barrier is generated by the electrode 35B.

As described before, the touch panel drive signal generation circuit 62 of the touch panel controller 60 generates each touch panel drive signal Txn (Tx1-Tx16) at the sensing period TSN (7.14 ms) (see FIG. 8) and supplies each touch panel drive signal Txn to the synthesizing circuit 70.

The SW signal generation circuit 81 generates the switching liquid crystal drive signal SW having a certain period and supplies the switching liquid crystal drive signal SW to the synthesizing circuit 70. For example, a frequency of the switching liquid crystal drive signal SW is 50 Hz and a period of the switching liquid crystal drive signal SW is 20 ms (see FIG. 8). In the present embodiment, the frame frequency (a frequency of a vertical synchronizing signal) is 60 Hz, and the sensing frequency (a frequency of the touch panel drive signal Txn) is 140 Hz, and the frequency of the switching liquid crystal drive signal SW is 50 Hz. Thus, the frequencies are different from each other. The touch panel drive signal Txn and the switching liquid crystal drive signal SW are not synchronous with each other.

As illustrated in FIGS. 7 and 9, the switching liquid crystal drive signal SW is a pulse signal having a low level of 0V and a high level of 5V. The SW signal generation circuit 81 generates the reverse phase switching liquid crystal drive signal SW-R. The reverse switching liquid crystal drive signal SW-R is applied to each electrode 34B. Namely, the switching liquid crystal drive signal is configured with the switching liquid crystal drive signal SW and the reverse phase switching liquid crystal drive signal SW-R each of which has a rectangular waveform having a same amplitude and a reverse phase. The switching liquid crystal drive signal SW is thus configured such that the liquid crystals are usually driven with AC drive to less likely to cause deterioration of the liquid crystals.

The synthesizing circuit 70 receives the touch panel drive signal Txn and the switching liquid crystal drive signal SW. The synthesizing circuit 70 switches the switching liquid crystal drive signal SW to each touch panel drive signal (Tx1-Tx16) in response to the synchronizing signal SYN and the switch signal SEL from the touch panel controller 60. Then, the synthesizing circuit 70 generates each common electrode signal (SC1-SC16) and supplies each common electrode signal (SC1-SC16) to the common electrode 34A. Each common electrode signal SCn is a signal that is switched from the switching liquid crystal drive signal SW to each touch panel drive signal Txn with time-division.

Specifically, if the synchronizing signal SYN is supplied to the 16-bit shift register 71 of the synthesizing circuit 70 at time t0 in FIG. 8, a first FF (flip-flop) in the shift register 71 is set and other FF are reset. The signal level of the set first FF is shifted by the switch signal SEL and one of the sixteen touch panel drive signals (Tx1-Tx16) is the one that is to be switched. According to an AND result of the AND circuit 72 with the one touch panel drive signal Txn and the corresponding switch signal SEL, the data selection circuit 73 switches the switching liquid crystal drive signal SW to the touch panel drive signal Txn (see FIG. 9) only at the timing of the switch signal SELn, that is, only during a period K2 while the switch signal SEL is at a high level (from time t1 to time t2 in FIG. 9). Accordingly, each common electrode signal (SC1-SC16) is sequentially generated and supplied to the corresponding common electrode 34A.

For example, the period K2 is 0.35 ms. In FIGS. 8 and 9, the time t0 and t4 at which the synchronizing signal SYN rises is a time at which switching from the switching liquid crystal drive signal SW to the touch panel drive signal Tx is started at a certain period ( 1/140 sec).

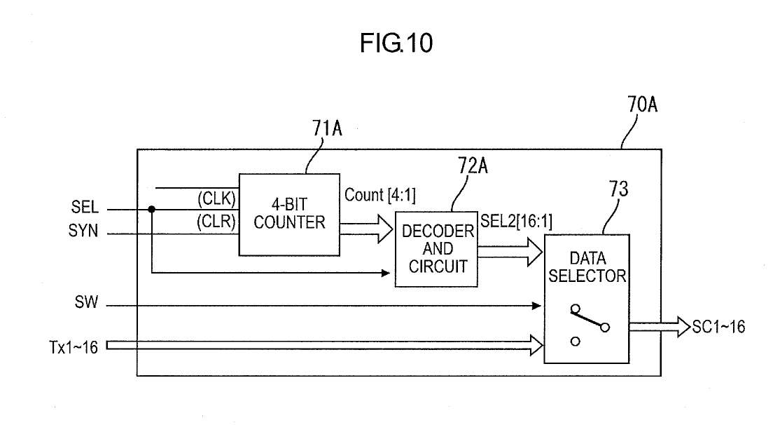

The configuration of the synthesizing circuit 70 is not limited to the one illustrated in FIG. 6 but may be a configuration of a synthesizing circuit 70A illustrated in FIG. 10. The synthesizing circuit 70A includes a 4-bit counter 71A and a decoder/AND circuit 72A instead of the 16-bit shift register 71 and the AND circuit 72 of the synthesizing circuit 70.

In such a case, the synchronizing signal SYN is supplied to the 4-bit counter 71A and the 4-bit counter 71A is reset by the synchronizing signal SYN. The 4-bit counter 71A starts to count up by the switch signal SLE that is subsequently input. A count value of the 4-bit counter 71A is decoded by a decoder of the decoder/AND circuit 72A and one of the touch panel drive signals Txn becomes one to be switched. Thereafter, similarly to the synthesizing circuit 70, the data selection circuit 73 generates each common electrode signal (SC1-SC16).

4. Operations and Advantageous Effects of the Present Embodiment

Thus, according to the present embodiment, the switching liquid drive signal SW is temporally switched to the touch panel drive signal Txn to generate the common electrode signal (synthesized signal) SCn. The touch panel controller 60 generates the switch signal SEL that specifies the switching period K2 and the synchronizing signal SYN that starts the switching from the switching liquid crystal drive signal SW to the touch panel drive signal Txn at a certain period (the sensing period TSN).

Therefore, even if the switching liquid crystal drive signal SW and the touch panel drive signal Txn are not synchronous with each other, the synthesizing circuit 70 generates the common electrode signal SCn based on the switch signal SEL and the synchronizing signal SYN. Namely, the common electrode signal SCn that is supplied to the common electrode 34A is generated easily and effectively from the touch panel drive signal Txn and the switching liquid crystal drive signal SW that are not synchronous with each other. The pulse period K2 of the switch signal SEL is determined corresponding to the period K3 of each detection pulse period D1, D2 of the touch panel drive signal Txn. Therefore, the pulse period K2 is set to be shorter than the period K1 of the touch panel drive signal Txn. As a result, the switching liquid crystal drive signal SW is less likely to receive influence.

### OTHER EMBODIMENTS

The present invention is not limited to the above embodiments described in the above description and the drawings. The following embodiments are also included in the technical scope of the present invention, for example.

(1) In the above embodiments, the touch panel 50 of a charge transmission method is used. However, a position detection method of the touch panel 50 is not limited thereto. For example, an electrostatic capacity of sensor electrodes included in the touch panel 50 may be directly measured (self-capacity detection method) to detect positions in the touch panel 50. Each of the touch panel transparent electrodes of the touch panel 50 is not necessarily formed in the shape described in the above embodiments (such that the transparent electrodes each extending in the X-axis and the Y-axis are overlapped with each other in a grid pattern).

(2) In the above embodiments, the switching liquid crystal electrode 34 extending in the Y-axis direction is formed on the common board 32 and the electrode 34 is used as the common electrode commonly used with the touch panel. However, it is not limited thereto. The switching liquid crystal panel electrode 35 extending in the X-axis direction may be formed on the common board 32 and the electrode 35 may be used as the common electrode.

(3) In the above embodiments, the electrodes 34A, 34B are formed on the lower surface of the common board 32 and the electrodes 34A are the common electrodes. However, it is not limited thereto and the electrodes 34B may be used as the common electrodes.

(4) The display devices of the above embodiments are configured so as to be applied to the portrait mode in which the display screen is in a vertical position and to the landscape mode in which the display screen is in a horizontal position. However, it is not limited thereto. For example, if the parallax barrier is used either one of the two modes, the electrodes 35 on the glass board 31 are not necessarily patterned and may be formed over an entire area of the glass board 31. In such a case, the present technology may be applied to the signal applied to the barrier electrodes formed on the glass board (common board) 32.

(5) In the above embodiments, the liquid crystal display device uses the liquid crystal panel as a display panel. However, the present technology is applicable to a display device using other type of display panel, for example, an EL panel.

### EXPLANATION OF SYMBOLS

10: liquid crystal display device (display device), 20: liquid crystal panel (display panel), 30: switching liquid crystal panel (parallax barrier), 32: common board, 34A: common electrode, 50: touch panel, 60: touch panel controller, 61: switch signal generation circuit, 62: touch panel drive signal generation circuit, 63: synchronizing signal generation circuit, 70: synthesizing circuit, 80: drive circuit (drive circuit of a display device), 81: switching liquid crystal drive generation circuit

1. A touch panel drive circuit that drives a touch panel of a display device including a display panel, the touch panel provided on a display surface side of the display panel, and a parallax barrier configured with a switching liquid crystal panel that enables three-dimensional display, the display device including a common board that is commonly used as a base board of the touch panel and one of two base boards of the switching liquid crystal panel, and further including a plurality of touch panel electrodes and switching liquid crystal electrodes provided on a same plane of the common board, the touch panel drive circuit comprising:
a touch panel drive signal generation circuit configured to generate a touch panel drive signal that drives the touch panel;
a switch signal generation circuit configured to generate a switch signal corresponding to a generation timing of the touch panel drive signal, the switch signal specifying a switching period during which a switching liquid crystal drive signal driving the switching liquid crystal panel is switched to the touch panel drive signal to be supplied to the common board; and
a synchronizing signal generation circuit configured to generate a synchronizing signal that starts switching from the switching liquid crystal drive signal to the touch panel drive signal at a predetermined period.

2. A drive circuit of a display device comprising:
the touch panel control circuit according to claim 1;
a switching liquid crystal drive signal generation circuit configured to generate the switching liquid crystal drive signal; and
a synthesizing circuit configured to switch from the switching liquid crystal drive signal to the touch panel drive signal in response to the switch signal and generate a synthesized signal and supply the synthesized signal to the common board.

3. The drive circuit according to claim 2, wherein
a common electrode is mounted on the common board to be commonly used as the touch panel electrode and the switching liquid crystal electrode, and
the synthesizing circuit supplies the synthesized signal to the common electrode.

4. The drive circuit according to claim 2, wherein the synthesizing circuit is initialized by the synchronizing signal in generating the synthesized signal.

5. The drive circuit according to claim 2, wherein the switching liquid crystal drive signal generation circuit receives a vertical synchronizing signal of the display device and generates the switching liquid crystal drive signal in synchronous with the vertical synchronizing signal.

6. A display device comprising the drive circuit according to claim 2.

7. The display device according to claim 6, wherein the display panel is a liquid crystal display panel using liquid crystals.
